(19) United States
(12) Patent Application Publication
(10) Pub. No.: US 2026/0120896 A1
(43) Pub. Date: Apr. 30, 2026

(54) INSERTS AND METHODS FOR CONTROLLING FUEL ASSEMBLY COOLANT FLOW RATES

(71) Applicant: GE-Hitachi Nuclear Energy Americas LLC, Wilmington, NC (US)

(72) Inventors: J. Scott Bowman, Wilmington, NC (US); Luisa M. Corredor, Folsom, CA (US); Bruce J. Lentner, Wilmington, NC (US)

(21) Appl. No.: 18/929,417

(22) Filed: Oct. 28, 2024

(51) Int. Cl. G21C 3/322; G21C 15/243; G21C 19/04

(52) U.S. Cl. CPC G21C 3/322; G21C 15/243; G21C 19/04

(57) ABSTRACT

Systems and methods use inserted controllers in assembly openings of nuclear fuel castings. The controllers can be secured entirely within the opening and condition coolant flow to a desired level for the associated assembly. The controllers can be installed or removed at any time through clamps or other securing structures accessible through the top of the opening. This may include during fuel removal or shuffling during a maintenance outage, or at casting construction and installation, or at decommissioning. Side orifices do not have to be accessed from below the core nor do the castings otherwise require movement or alteration. Any desired flow characteristics may be selected and achieved through use of the configured controllers at specific core locations. Size, shape, and flow surfaces can all be configured to achieve these characteristics where they permit the controller to fit in the casting.

### BACKGROUND

A related art nuclear reactor, such as a Boiling Water Reactor (BWR), is shown in FIG. 1. The reactor includes reactor pressure vessel 12 housing nuclear fuel core 36 that generates power through nuclear fission. Vessel 12 may be of a generally cylindrical shape, closed at a lower end by bottom head 28 and at a top end by removable top head 29. Cylindrically-shaped core shroud 34 may surround reactor core 36, which includes several nuclear fuel elements or assemblies. Shroud 34 may be supported at one end by shroud support 38 and may include removable shroud head 39 and separator tube assembly at the other end. One or more control blades 20 or other control elements may extend upwards into core 36, so as to control the fission chain reaction within fuel elements of core 36. Additionally, one or more instrumentation tubes 50 may extend into reactor core 36 from outside vessel 12, such as through bottom head 28, permitting instrumentation, such as neutron monitors and thermocouples, to be inserted into and enclosed within the core 36 from an external position.
Fuel assemblies may be aligned and supported by fuel support castings 48 located on core plate 49 at a base of core 36. Castings 48 may receive individual fuel assemblies or groups of assemblies and permit coolant flow through the same. Fuel support castings 48 may further permit control blades 20, to pass into core 36. A fluid, such as light water, is circulated up through core plate 49 and core 36, and in a BWR, is at least partially converted to steam by the heat generated by fission in the fuel elements. The steam is separated and dried in separator tube assembly and steam dryer structures 15 and exits vessel 12 through a main steam line 3 near a top of vessel 12. Other fluid coolants and/or moderators may be used in other reactor designs, with or without phase change.
FIGS. 2A and 2B are detailed views of related art fuel support casting 48 useable in the nuclear reactor of FIG. 1 that can receive and support up to four individual fuel assemblies. As shown in FIGS. 2A and 2B, casting 48 includes openings 90 shaped to receive a lower end of a fuel assembly so as to support and align assemblies seated in fuel support casting 48. Openings 90 are open and permit coolant flow 80 through fuel support casting 48 into fuel assemblies supported thereon. Lower orifices 95 may provide fluid entrance into casting 48 to flow up length 91.
A cruciform or other opening 21 may permit control blade 20 (FIG. 1) to pass between assemblies supported by fuel support casting 48. It is understood however, that control blades 20 may not be present in every possible core location, such that opening 21 may be unfilled or nonexistent. Non-patent literature “General Electric Systems Technology Manual,” Dec. 14, 2014, Chapters 2.1 and 2.2, describe other related art reactor support castings and are incorporated by reference herein in their entireties.
This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments include insertable flow controllers that fit into assembly openings of nuclear fuel castings typically positioned at a bottom of the nuclear core. The controllers can include a cartridge body that can be secured to an inside of the opening, with a flow passage that modifies the coolant flow characteristics through the opening. The controllers can also include a clamping structure that secures the controller in the opening for installation and/or nondestructive removal. Any kind of securing is useable in example embodiments, including an L-shaped clamp arm that can be vertically tightened against an inlet orifice of the castings by a nut on either side of the insert. Single or multiple arms can be used, with individual or universal tightening structures for drawing the clamp being accessible through the top of the opening. The controllers can have any shape that permits their insertion into an opening and securing in the same, including rounded, prismatic, or cylindrical shapes that may match opening inner surfaces in whole or in part. The flow path provided by the inserted controller may be the only flow path through the opening, allowing full control of the flow characteristics through the opening and into the fuel assembly seated therein.
Example methods may install, move, and/or remove flow controllers at any time the casting is accessible. This may include during fuel removal or shuffling during a maintenance outage, or at casting construction and installation or decommissioning. The installation may need only access to the top opening of the casting for positioning and securing of example embodiments, with no need to access a side inlet orifice or otherwise manipulate the fuel casting. Flow path size, shape, and resultant flow characteristics may be selected based on desired coolant flow through individual fuel locations. In this way, the configuration of the flow path in example embodiments and installation of the same at particular core locations permit granular, assembly-level customization of coolant flow through a nuclear core.

### BRIEF DESCRIPTIONS OF THE DRAWINGS

Example embodiments will become more apparent by describing, in detail, the attached drawings, wherein similar elements are represented by similar reference numerals. The drawings serve purposes of illustration only and thus do not limit example embodiments herein. Elements in these drawings may be to scale with one another and exactly depict shapes, positions, operations, and/or wording of example embodiments, or some or all elements may be out of scale or embellished to show alternative proportions and details.
FIG. 1 is a cross-section illustration of a related art nuclear reactor and its internals.
FIG. 2A is a cross-section illustration of a related art nuclear fuel casting.
FIG. 2B is a top view of the related art nuclear fuel casting.
FIG. 3B is a top view of the related art nuclear fuel casting.
FIG. 3A is an illustration of an example embodiment insert for use in a nuclear fuel casting.
FIG. 3B is an exploded illustration of the example embodiment insert of FIG. 3A.
FIG. 4 is an illustration of another example embodiment insert for use in a nuclear fuel casting.
FIG. 5 is a cross-section illustration of a fuel casting with an example embodiment insert installed.
FIG. 6 is an illustration of a fuel casting with another example embodiment insert installed.

### DETAILED DESCRIPTION

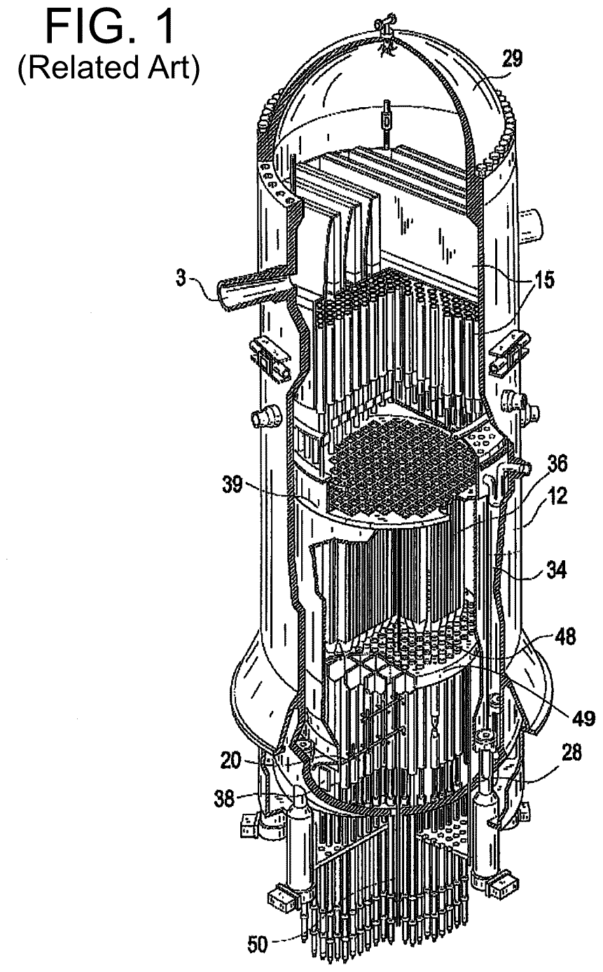

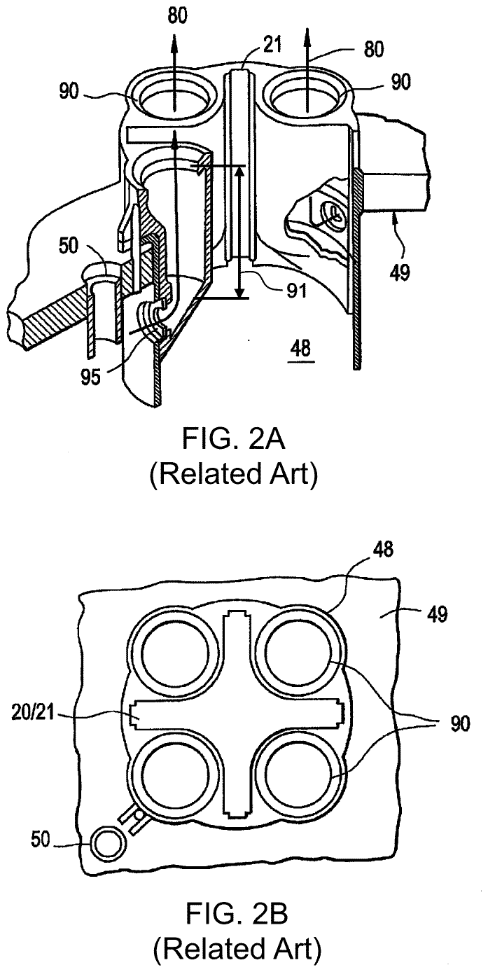

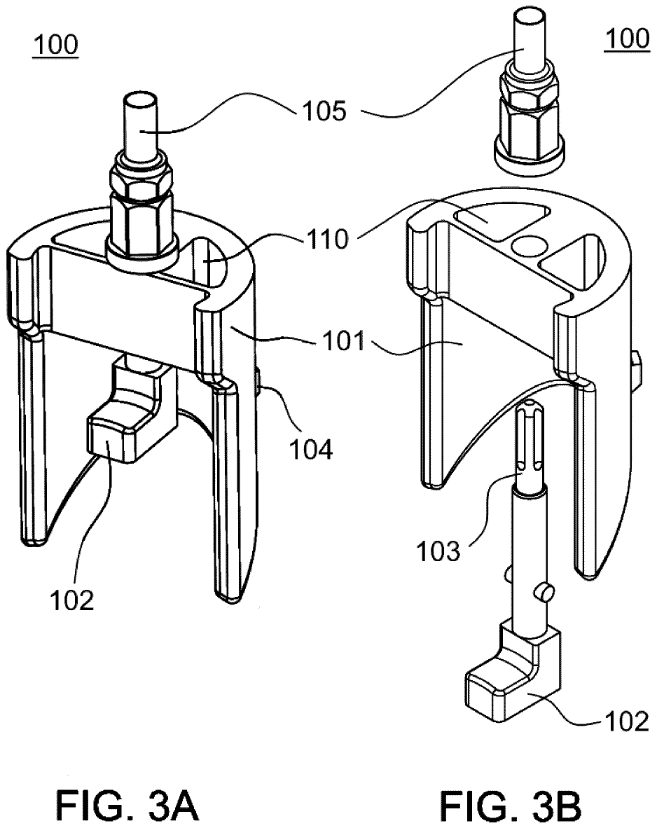

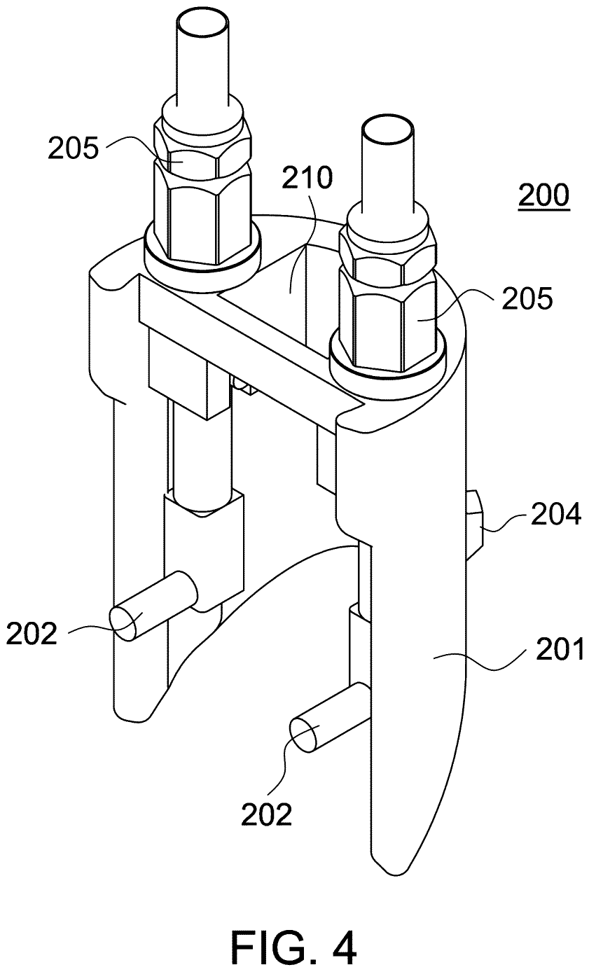

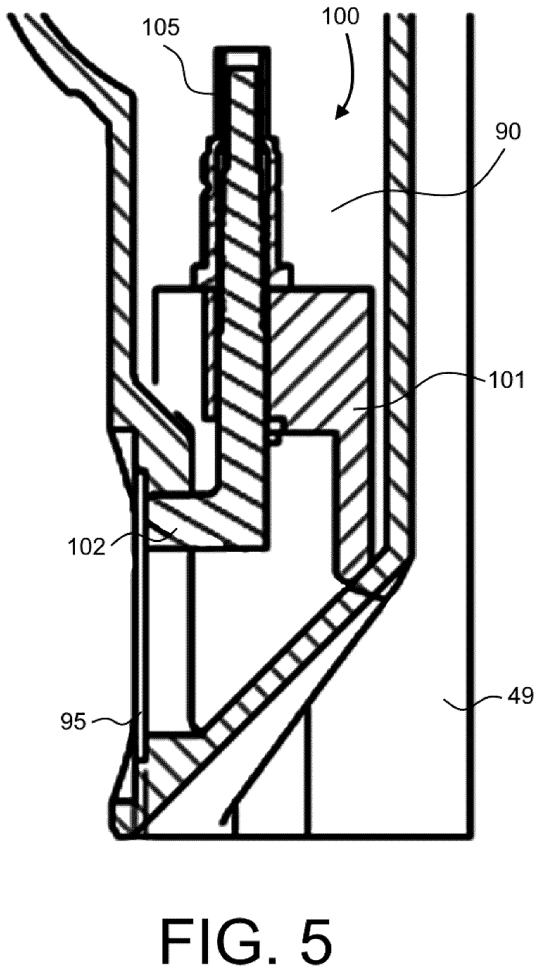

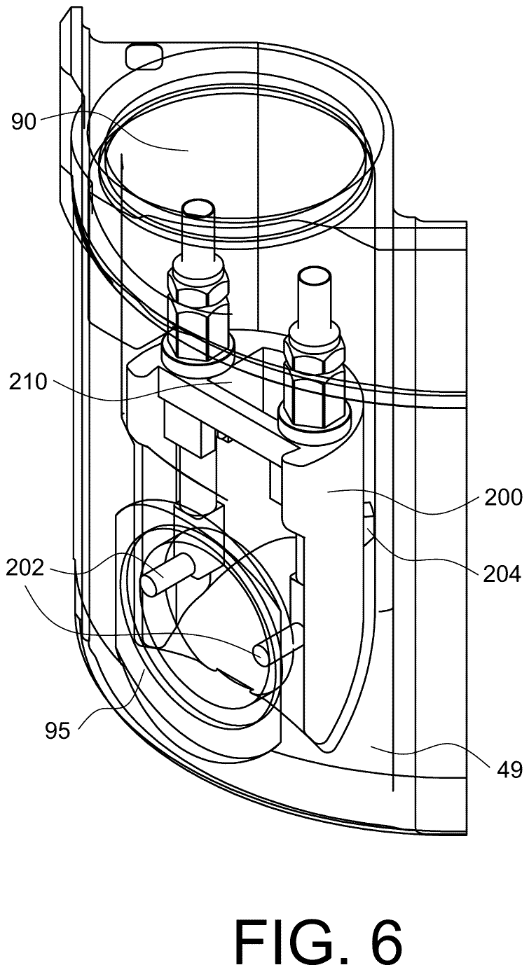

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.
Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion.
In listing items in example embodiments, conjunctions and inclusive terms like “and,” “with,” and “or” include all combinations of one or more of the listed items without exclusion of non-listed items. The use of “etc.” is defined as “et cetera” and indicates the inclusion of all other elements belonging to the same group of the preceding items, in any “and/or” combination(s). Modifiers “first,” “second,” “another,” etc. do not confine modified items to any order. These terms are used only to distinguish one element from another; where there are “second” or higher ordinals, there merely must be that many number of elements, without necessarily any difference or other relationship among those elements.
When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,”“adjacent”versus “directly adjacent,”etc.).
As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the”refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”
The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.
Proportions, sizes, and shapes shown in the figures are examples for illustration. While they reflect features of some example embodiments, other relationships and magnitudes of dimensions are included in these examples. As used herein, “azimuthal” and “angular” directions substantially follow a rounded perimeter of a referenced feature, and “radial” directions substantially follow a radius of that rounded perimeter, perpendicular to the angular direction. “Vertical” and height directions substantially follow an up-down orientation, orthogonal to the radial and angular directions of a referenced feature. “Length” and “width” are substantially perpendicular dimensions of a referenced feature, with “length” generally being a longest dimension of the feature.
The inventors have recognized a need for finer control of coolant flow through a nuclear core, from whole core flow down to individual assembly flow characteristics. Reactor pressure vessel shaping and plenum internals, however, cannot be easily accessed or modified, and changing flow characteristics typically requires modification of whole-core flows or modification of the fuel assemblies themselves to permit different flow levels. Fuel assemblies, however, change through their lifetime to have different nuclear reactivity and different flow needs, as well as different core positions, such that the assembly configuration may become inapplicable, and changing assembly shaping or flow characteristics risks interaction with highly-activated assemblies during maintenance periods as well as introduction of loose parts within the assembly itself. To overcome these newly-recognized problems as well as others, the inventors have developed example embodiments and methods described below to address these and other problems recognized by the inventors with unique solutions enabled by example embodiments.
The present invention is nuclear fuel casting inserts, nuclear cores containing the same, and methods of installing, using, and/or removing the same. In contrast to the present invention, the few example embodiments and example methods discussed below illustrate just a subset of the variety of different configurations that can be used as and/or in connection with the present invention.
FIG. 3A is an illustration of an example embodiment insert 100 useable in a nuclear fuel casting, such as related art casting 48 of FIGS. 2A and 2B. Insert 100 is shaped and sized to fit within an opening of the casting to modify the flow characteristics of fluid coolant through the same. For example, insert 100 may include an annular cartridge 101 shaped to line an opening carrying flow through the casting and secure in the same. Cartridge 101 may have a radial thickness to limit flow area and/or include flow paths 110 sized to limit or direct flow through insert 100 to a desired level. For example, one or more flow paths 110 may pass through an entire vertical length of cartridge 100 and reduce flow, or shape flow through bends or swirl vanes in flow paths 110, or direct flow, depending on the size, perimeter, and shape of flow paths 110.
Any shapes or sizes of cartridge 101 that fit within the fuel casting opening, and well as any configuration and number of flow paths 110, may be used to achieve a desired flow path or amount. For example, if example embodiment insert 100 is used in castings for outer periphery burnt flow assemblies, cartridges 101 with thicker radial walls and smaller flow paths 110 may be used to restrict coolant flow through these lower power assemblies. Similarly, flow paths 110 may be smaller, fewer in number, labyrinthine, or having swirling surfaces, baffles, choke points, etc. to achieve lower flows in such an example.
As seen in FIG. 3A, cartridge 101 may include contact 104 that seats against or secures with an inner wall of the opening of the casting. Contacts 104 may be an extension of cartridge 101 or any other specially-shaped piece fixed to cartridge 101. Alternatively, cartridge 101 may be shaped and sized to match an inner periphery the opening and seat continuously therewith. Similarly, contacts 104 may be positioned at vertical or any other position to achieve desired seating and securing in the openings, or omitted entirely. If openings have variable sizes, such as smaller termina to receive fuel assemblies, one or more contacts 104 may allow easier insertion of cartridge 101 through the smaller areas through tilting an/or rotation while still contacting or securing with the walls in the openings when seated into place.
As shown in FIGS. 3A and 3B, example embodiment insert 100 includes a clamp that can removably secure the insert 101 when placed within a casting opening. For example, the clamp may include clamp arm 102 having a foot that is vertically moveable to tighten and bias against casting structures to secure insert 100. The clamp may be tightened through any movement, including by crimp nut 105 and matching threads on clamp arm 102 that draw clamp arm 102 in a desired vertical position and tightness. For example, clamp arm 102 may extend through flow path 110 or another hole in cartridge 101 with crimp nut 105 securing to clamp arm 102 on another side of flow path 110. Crimp nut 105 may be a single piece assembly and may be deformable about clamp arm 102 to lock the clamp at a desired position while eliminating additional loose pieces. Similarly, any other biasing structure can be used, including a ratchet, leaf spring, expansive jaw, cinch clamp, etc., for the clamp to secure insert 101 into a respective fuel casting opening.
FIG. 4 is an illustration of example embodiment insert 200 useable with and having interchangeable parts with example embodiment insert 100 and illustrating another clamp useable instead or in combination with the clamp of insert 100. As shown in FIG. 4, multiple clamp arms 202 may be used at different angular positions where arms 202 may seat into and against lower openings or orifices 95 (FIG. 2A) of fuel castings. The divergent angular positions of arms 202 on opposite inner sides of cartridge 201 may permit insertion of arms 202 into sides of the orifice to ensure correct angular orientation of insert 200 in an opening of the casting. Individual or a combined tightening structures may be used to bias arm 202, such as crimp nuts 205 at an end of each arm 202 passing through cartridge 201, similar to that of FIGS. 3A-3B. Individual or plural crimp nuts 205 may be at a vertical topmost position of the clamp, further facilitating tightening and loosening of example embodiment inserts through a top, easily-accessed entrance of the casting. Similarly, flow path 210 and/or contact 204 may be of any shape or position to accommodate multiple arms 202.
Example embodiment inserts may be fabricated of resilient materials that are compatible with a nuclear reactor environment without substantially changing in physical properties, such as becoming substantially radioactive, melting, embrittling, and/or retaining/adsorbing radioactive particulates. For example, several known structural materials, including austenitic stainless steels 304 or 316, XM-19, zirconium alloys, nickel alloys, Alloy 600, etc. may be chosen for any element of components of example embodiment inserts. Direct connections between distinct parts and all other direct contact points may be lubricated, insulated, coated, and/or fabricated of alternating or otherwise compatible materials to prevent seizing, fouling, metal-on-metal reactions, fretting, conductive heat loss, etc.
FIGS. 5 and 6 illustrate example installation configurations of example embodiment inserts 100 and 200. Example embodiment inserts may be selected, configured, and/or installed to achieve desired flow characteristics through a fuel casting, control cell, and even entire fuel core in a reactor. For example, flow paths 110/210 may be sized based on known core flow and power conditions, to limit or enhance moderator flow and thus burnup through a corresponding assembly seated into the casting using inserts 100 or 200. For example, burnt fuel assemblies at a periphery may be matched with fuel casting openings fitted with particularly constrictive or closed inserts 100 and 200 to reduce moderator flow and waste through those assemblies. Similarly, fresh and higher reactivity assemblies may be fitted with no insert or more open inserts 100 and 200 that enhance moderator flow and burnup as well as energy transfer to the moderator. In this way, any desired flow level and characteristic may be set at a fine, assembly-level basis by installing example embodiment inserts in fuel casting openings having flow paths that achieve the desired flow. Flow distribution across the entire core may thus be affected and configured in a desired level through planning and placement of correspondingly-sized inserts into the associated fuel castings.
Example methods may install inserts 100 and/or 200 at any desired point when the fuel casting housing the same is accessible, such as during a maintenance outage, for insertion into existing fuel castings as fuel is shuffled, during plant or casting manufacture, or during on-site preparation. Example embodiment inserts may be installed through a vertical top of opening 90 of casting 49, due to their size and shaping to fit within the casting and the opening. Contacts, seals, and fittings may optionally be used with inserts 100 and 200 to achieve a desired fit and positioning. In this way, lower orifice 95 shown in FIGS. 5 and 6 need not be accessed from under a core and through an inaccessible transverse direction. Example embodiment inserts are also removable, such that they can be swapped or reinstalled in different casting positions based on desired flow characteristics.
No particular tooling, manipulation of casting 49, or removal of pieces is necessary to lower inserts 100 or 200 into associated fuel casting openings. For example, inserts 100/200 may be positioned into opening 90 and completely fit within the same without protruding or interfering with any other casting for fuel component. Example embodiment inserts 100 or 200 may be positioned such that clamp arm(s) 102/202 pass through lower orifice 95 of casting 49 with cartridge 101/201 secured with or directly seated against an interior of opening 90. The positioning of arm(s) 102/202 with respect to orifice 95 may ensure inserts 100 and 200 are at the proper vertical height and radial position. The clamp may then be tightened, such as through rotation of crimp nut 105/205 on threads of arm(s) 102/202 to secure the insert by seating against interior surfaces of opening 90. For example, arm 105/205 may frictionally secure against an upper horizontal surface of opening 90, while cartridge 101/201 frictionally secures against a lower horizontal surface of opening 90 through tightening of a clamp. The position and secure frictional fit may be held by deformation of crimp nut 105/205 at a desired tightness. Of course, any other clamping or fixing process may secure inserts 100 or 200 into a respective opening. Reversal of the clamp structure may similarly allow non-destructive removal to reconfigure or reposition the insert.
As installed in fuel casting 49 as shown in FIGS. 5 and 6, example embodiment inserts provide a customized flow path through flow paths 110/210 and other shapes, distinct from that of opening 90 in fuel casting 49. During operation, a liquid moderator and/or coolant, such as light water, may pass through example embodiment inserts in a vertical direction, entering from orifice 95, passing up through cartridge 101/201, and through any flow paths 110/210 to ultimately exit opening 90 into a fuel assembly supported above the same. The flow may be controlled and shaped by example embodiment inserts 100/200 to provide a desired flow rate, direction, division, swirl, etc.
Some example embodiments and methods thus being described, it will be appreciated by one skilled in the art that examples may be varied through routine experimentation and without further inventive activity. For example, although some inserts with partially-annular shapes are shown in some casting openings, it is understood that any other shapes and sizes are useable with example embodiments and methods. Variations are not to be regarded as departure from the spirit and scope of the example embodiments, and all such modifications as would be obvious to one skilled in the art are intended to be included within the scope of the following claims. The claims below are not intended to be construed under 35 U.S. C. §112(f) unless explicit means-plus-function language “means for” and “step for” are recited therein.

1. An insert for use in a nuclear fuel casting having an opening passing through the casting for coolant flow through the casting, the insert comprising:
a cartridge shaped to fit inside the opening, wherein the cartridge includes a flow path entirely through the cartridge and distinct from a flow path of the opening so as to modify flow characteristics of the coolant flow through the casting; and
a clamp configured to secure the insert in the opening.

2. The insert of claim 1, wherein the insert is sized to fit entirely within the opening with no element extending outside the fuel casting.

3. The insert of claim 1, wherein the clamp includes a clamp arm extending vertically through the cartridge and a clamp head extending horizontally.

4. The insert of claim 3, wherein the clamp further includes a crimp nut on an end of the clamp arm opposite the clamp head, wherein the crimp nut is configured to lock the clamp in place when deformed against the clamp arm.

5. The insert of claim 4, wherein the clamp includes a plurality of the clamp arms and crimp nuts.

6. The insert of claim 5, wherein the clamp arms are spaced from each other in a transverse direction at two opposite positions inside the cartridge from each other.

7. The insert of claim 3, wherein the clamp head is shaped to extend into an inlet orifice of the casting with the insert in the opening.

8. The insert of claim 1, wherein the cartridge is at least partially annular, and wherein a surface of the annulus is a matching shape of the opening that is cylindrical.

9. The insert of claim 1, wherein the insert when installed in the opening is shaped such that there is no flow path through the opening and outside the insert.

10. A fuel casting for a nuclear reactor, the fuel casting comprising:
four openings each connecting from a vertically lower position to a topmost outlet shaped to receive and support a base of a fuel assembly; and
the insert of claim 1 secured in at least one of the openings.

11. The casting of claim 10, wherein each of the openings include an inlet orifice facing a transverse direction, and wherein the insert is clamped to a surface of the orifice.

12. The casting of claim 10, wherein all four openings include one of the inserts secured in the respective opening.

13. The casting of claim 10, wherein the insert is sized to fit entirely within the opening with no element extending outside the fuel casting.

14. A method of reconfiguring coolant flow through a nuclear reactor core, the method comprising:
installing an insert into an opening of a fuel casting to alter flow characteristics of the coolant through the fuel casting and into a fuel assembly seated into the opening.

15. The method of claim 14, wherein the installing includes clamping the insert to an inlet orifice of the opening.

16. The method of claim 14, wherein the casting is on an outer edge of the core and wherein the fuel assembly is a burnt fuel assembly.

17. The method of claim 14, wherein the insert includes a cartridge with a flow path entirely through the cartridge and distinct from a flow path of the opening so as to alter the flow characteristics of the coolant flow through the opening.

18. The method of claim 14, wherein the installing includes passing the insert vertically downward into the opening and securing the insert in the opening without accessing an inlet orifice of the opening from an exterior of the casting.

19. The method of claim 14, wherein the clamp includes a clamp arm extending vertically through a cartridge and a clamp head extending horizontally, wherein the clamp further includes a crimp nut on an end of the clamp arm opposite the clamp head, and wherein the installing includes deforming the crimp nut to lock the clamp in place.

20. The method of claim 14, further comprising:
repeating the installing for each of a plurality of the inserts and the openings within the core.
